(19) United States
(12) Patent Application Publication
(10) Pub. No.: US 2023/0269723 A1
(43) Pub. Date: Aug. 24, 2023

(54) ELECTRONIC DEVICE SUPPORTING PLURALITY OF WI-FI-BASED COMMUNICATION SCHEMES, AND METHOD FOR CONTROLLING SAME

(71) Applicant: SAMSUNG ELECTRONICS CO., LTD., Suwon-si (KR)

(72) Inventors: Buseop JUNG, Suwon-si (KR); Hyejung BANG, Suwon-si (KR); Soonho LEE, Suwon-si (KR); Sunkey LEE, Suwon-si (KR)

(73) Assignee: SAMSUNG ELECTRONICS CO., LTD., Suwon-si (KR)

(21) Appl. No.: 18/139,727

(22) Filed: Apr. 26, 2023

Related U.S. Application Data
(63) Continuation of application No. PCT/KR2021/012585, filed on Sep. 15, 2021.

(30) Foreign Application Priority Data
Nov. 6, 2020 (KR) 10-2020-0147211

(51) Int. Cl. H04W 72/12

(52) U.S. Cl. CPC H04W 72/1215; H04W 88/06

(57) ABSTRACT

An electronic device includes: a transceiver; and a communication processor operatively connected with the transceiver. The communication processor is configured to: identify an active state or an inactive state of a neighbor awareness networking (NAN)-based first communication scheme; obtain NAN cluster information; increase a group owner (GO) intent in a Wi-Fi direct-based second communication scheme; determine that the electronic device is a group owner of the Wi-Fi direct-based second communication scheme, and divide a time period into at least one first period and at least one second period; obtain schedule information indicating that one communication scheme operates in the at least one first period and the other communication scheme operates in the at least one second period; and control the transceiver to transmit a signal based on the schedule information. The one communication scheme uses a same channel with the NAN-based first communication scheme and the other communication scheme uses a different channel.

### CROSS-REFERENCE TO RELATED APPLICATIONS

This application is a by-pass continuation application of International Application No. PCT/KR2021/012585, filed on Sep. 15, 2021, which is based on and claims priority to Korean Patent Application No. 10-2020-0147211, filed on Nov. 6, 2020, in the Korean Intellectual Property Office, the disclosures of which are incorporated by reference herein their entireties.

### BACKGROUND

### 1. Field

The disclosure relates to an electronic device concurrently supporting a plurality of communication schemes based on Wi-Fi and a method for controlling the same.

### 2. Description of Related Art

There are electronic devices, systems, and methods for short-range communication connection.

Various proximity-based services using low-power discovery technology and short-distance communication technology have been developed. One example of those proximity-based services is low-power proximity utilization using a Bluetooth Low Energy (BLE) beacon. An advertising service may be provided by using a proximity service and sharing various pieces of information between short-range User Equipments (UEs) through low-power BLE beacon transmission.

Among short-range communication schemes, Wi-Fi direct (or Wi-Fi peer-to-peer) is a technique that may establish a direct connection between Wi-Fi electronic devices using a Wi-Fi interface without passing through an access point (AP) that is an infrastructure network medium. Electronic devices connected together via Wi-Fi direct may be called a Peer-to-Peer (P2P) group or communication group. One electronic device in the P2P group operates as a group owner, and the remaining electronic devices operate as group clients.

Neighbor awareness networking (NAN), which is another short-range communication scheme, is a low-power discovery technology, and development of a short-range proximity service using this technology is in active progress.

The NAN standard only defines concurrent operation between NAN technology and other types of Wi-Fi-based communication schemes, but does not define specific methods.

Various current Wi-Fi chipsets support concurrent operation of the NAN-based communication scheme and other communication schemes only in a limited manner. Currently, NAN-based communication scheme and WLAN station (STA) mode-based communication scheme are concurrently supported, but concurrent support with other Wi-Fi-based communication schemes may be impossible.

In particular, concurrent support of PEP-type technologies, such as Wi-Fi direct and NAN technology may be impossible.

### SUMMARY

Provided are an electronic device concurrently supporting a plurality of communication schemes based on Wi-Fi while minimizing performance deterioration and a method for controlling the same.

According to an aspect of the disclosure, an electronic device includes: a transceiver; and a communication processor operatively connected with the transceiver, wherein the communication processor is configured to: identify whether a neighbor awareness networking (NAN)-based first communication scheme is in an active state or an inactive state; based on the NAN-based first communication scheme being in the active state, obtain NAN cluster information; based on the NAN-based first communication scheme being in the active state, increase a group owner (GO) intent in a Wi-Fi direct-based second communication scheme; determine, based on the GO intent, that the electronic device is a group owner of the Wi-Fi direct-based second communication scheme, and divide a time period into at least one first period and at least one second period, the time period is being designated by a discovery window (DW) identified based on the NAN cluster information; obtain schedule information indicating that one communication scheme from among the Wi-Fi direct-based second communication scheme and a STA mode-based third communication scheme operates in the at least one first period, and the other communication scheme from among the Wi-Fi direct-based second communication scheme and the STA mode-based third communication scheme operates in the at least one second period, wherein the one communication scheme uses a same channel as the NAN-based first communication scheme and the other communication scheme uses a different channel than the NAN-based first communication scheme; and control the transceiver to transmit a signal according to the Wi-Fi direct-based second communication scheme, based on the schedule information.

The signal according to the Wi-Fi direct-based second communication scheme may be a beacon signal of the Wi-Fi direct-based second communication scheme including the schedule information.

The communication processor may be further configured to control the transceiver to transmit the signal according to the Wi-Fi direct-based second communication scheme in the at least one first period.

The communication processor may be further configured to divide a time period between a start time of a first DW and a start time of a second DW into the at least one first period and the at least one second period, and each of the at least one first period and the at least one second period may be a multiple of a time slot defined according to the NAN-based first communication scheme.

The communication processor may be further configured to: if based on the NAN-based first communication scheme being in the active state, obtain NAN cluster synchronization information as the NAN cluster information; based on the NAN-based first communication scheme being in the inactive state, perform a NAN passive scan operation; based on neighboring NAN cluster information being received based on the NAN passive scan operation, obtain the received neighboring NAN cluster information as the NAN cluster information; and based on the neighboring NAN cluster information is not being received based on the NAN passive scan operation, generate arbitrary NAN cluster information.

The communication processor may be further configured to: based on the NAN-based first communication scheme being in the active state, increase the GO intent by a first value; and based on the NAN-based first communication scheme being in the inactive state, increase the GO intent by a second value lower than the first value.

The communication processor may be further configured to increase the GO intent based on a frequency band of an access point connected in the STA mode-based third communication scheme.

The communication processor may be further configured to obtain the schedule information after performing time synchronization on the NAN-based first communication scheme, the Wi-Fi direct-based second communication scheme, and the STA mode-based third communication scheme.

The electronic device may further include a memory, and the communication processor may be further configured to: control the transceiver to transmit a discovery message of the Wi-Fi direct-based second communication scheme including NAN cluster information stored in the memory; receive a response signal to the discovery message; and obtain one having a higher master rank of NAN cluster information about a counterpart device in the response signal and the transmitted NAN cluster information, as the NAN cluster information.

The communication processor may be further configured to: based on the NAN cluster information being changed into information about another NAN cluster based on merging with the other NAN cluster, obtain schedule information changed based on the changed NAN cluster information, and control the transceiver to transmit a signal according to the Wi-Fi direct-based second communication scheme, based on the changed schedule information.

The communication processor may be further configured to, based on the NAN-based first communication scheme being activated while operating in the Wi-Fi direct-based second communication scheme, and another activated NAN cluster being detected, set a master rank of the NAN cluster information to a maximum value.

According to an aspect of the disclosure, a method performed by an electronic device, includes: identifying whether a neighbor awareness networking (NAN)-based first communication scheme is in an active state or an inactive state; based on the NAN-based first communication scheme being in the active state, obtaining NAN cluster information; based on the NAN-based first communication scheme being in the active state, increasing a group owner (GO) intent in a Wi-Fi direct-based second communication scheme; determining, based on the GO intent, that the electronic device is an owner device of the Wi-Fi direct-based second communication scheme, and dividing a time period into at least one first period and at least one second period, the time period being designated by a discovery window (DW) identified based on the NAN cluster information; obtaining schedule information indicating that one communication scheme from among the Wi-Fi direct-based second communication scheme and a STA mode-based third communication scheme operates in the at least one first period, and the other communication scheme from among the Wi-Fi direct-based second communication scheme and the STA mode-based third communication scheme operates in the at least one second period, wherein the one communication scheme uses a same channel as the NAN-based first communication scheme and the other communication scheme uses a different channel than the NAN-based first communication scheme; and transmitting a signal according to the Wi-Fi direct-based second communication scheme, based on the schedule information.

The signal according to the Wi-Fi direct-based second communication scheme may be a beacon signal of the Wi-Fi direct-based second communication scheme including the schedule information.

The transmitting the signal may include transmitting the signal according to the Wi-Fi direct-based second communication scheme in the at least one first period.

The dividing the time period may include dividing a time period between a start time of a first DW and a start time of a second DW into the at least one first period and the at least one second period, and each of the at least one first period and the at least one second period may be a multiple of a time slot defined according to the NAN-based first communication scheme.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates an electronic device in a network environment according to one or more embodiments;

FIG. 2 illustrates communication connections of electronic devices according to one or more embodiments;

FIG. 3 illustrates a control operation of a communication module for using a plurality of communication schemes according to one or more embodiments;

FIG. 4 illustrates an operation of obtaining NAN cluster information about a communication module according to one or more embodiments;

FIG. 5 illustrates an operation of obtaining schedule information for using a plurality of communication schemes of a communication module according to one or more embodiments;

FIG. 6 illustrates schedule information obtained to use a plurality of communication schemes according to one or more embodiments;

FIG. 7 illustrates an operation of obtaining NAN cluster information about a communication module according to one or more embodiments;

FIG. 8 illustrates a reconnection operation in a Wi-Fi scheme of a communication module according to one or more embodiments; and

FIG. 9 illustrates operations of a communication module when a NAN cluster is activated while a communication module operates in a Wi-Fi direct scheme according to one or more embodiments.

### DETAILED DESCRIPTION

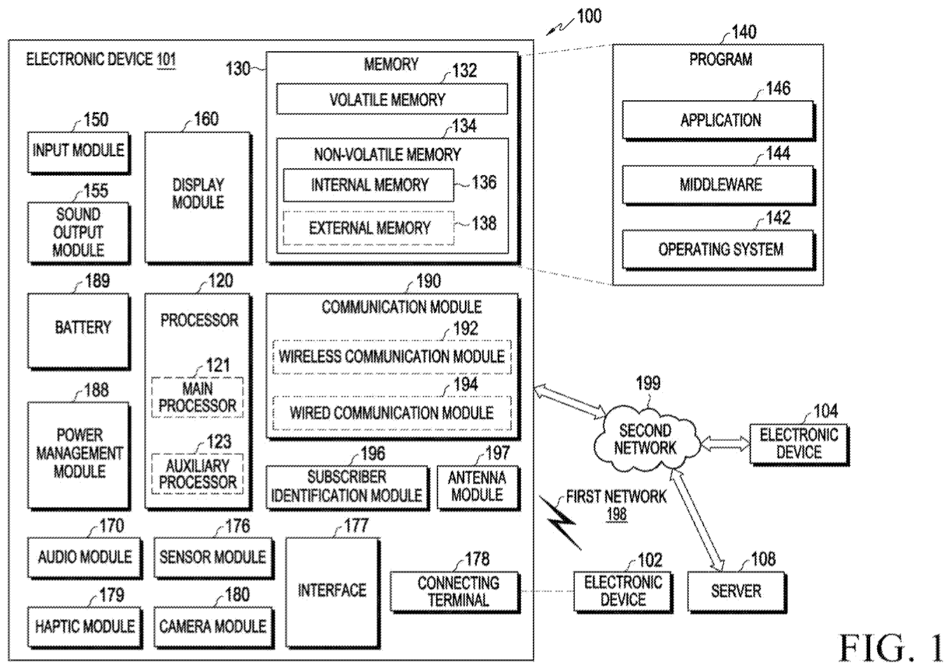

FIG. 1 is a block diagram illustrating an electronic device 101 in a network environment 100 according to various embodiments. Referring to FIG. 1, the electronic device 101 in the network environment 100 may communicate with an electronic device 102 via a first network 198 (e.g., a short-range wireless communication network), or an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In an embodiment, at least one (e.g., the connecting terminal 178) of the components may be omitted from the electronic device 101, or one or more other components may be added in the electronic device 101. According to an embodiment, some (e.g., the sensor module 176, the camera module 180, or the antenna module 197) of the components may be integrated into a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be configured to use lower power than the main processor 121 or to be specified for a designated function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. The artificial intelligence model may be generated via machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by other component (e.g., the processor 120) of the electronic device 101, from the outside (e.g., a user) of the electronic device 101. The input module 150 may include, for example, a microphone, a mouse, a keyboard, keys (e.g., buttons), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor configured to detect a touch, or a pressure sensor configured to measure the intensity of a force generated by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an accelerometer, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or motion) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device 104 via a first network 198 (e.g., a short-range communication network, such as Bluetooth™, wireless-fidelity (Wi-Fi) direct, or infrared data association (IrDA)) or a second network 199 (e.g., a long-range communication network, such as a legacy cellular network, a 5G network, a next-generation communication network, the Internet, or a computer network (e.g., local area network (LAN) or wide area network (WAN)). These various types of communication modules may be implemented as a single component (e.g., a single chip), or may be implemented as multi components (e.g., multi chips) separate from each other. The wireless communication module 192 may identify or authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device). According to an embodiment, the antenna module 197 may include one antenna including a radiator formed of a conductive body or conductive pattern formed on a substrate (e.g., a printed circuit board (PCB)). According to an embodiment, the antenna module 197 may include a plurality of antennas (e.g., an antenna array). In this case, at least one antenna appropriate for a communication scheme used in a communication network, such as the first network 198 or the second network 199, may be selected from the plurality of antennas by, e.g., the communication module 190. The signal or the power may then be transmitted or received between the communication module 190 and the external electronic device via the selected at least one antenna. According to an embodiment, other parts (e.g., radio frequency integrated circuit (RFIC)) than the radiator may be further formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. The external electronic devices 102 or 104 each may be a device of the same or a different type from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an Internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or health-care) based on 5G communication technology or IoT-related technology.

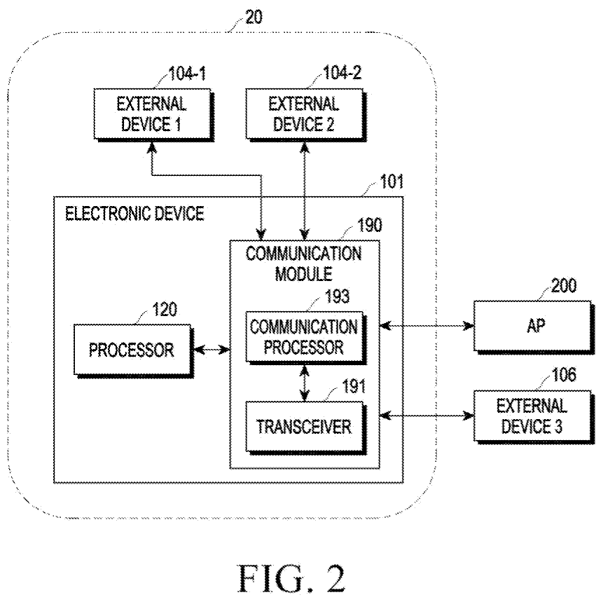

FIG. 2 is a view illustrating communication connections of electronic devices according to one or more embodiments.

According to one or more embodiments, referring to FIG. 2, an electronic device 101 (e.g., the electronic device 101 of FIG. 1) may be connected with a plurality of external devices (e.g., the external device 1 104-1, the external device 2 104-2, the external device 3 106, and the AP 200) based on a plurality of communication schemes based on Wi-Fi.

According to one or more embodiments, the electronic device 101 may include a processor 120 (e.g., the processor 120 of FIG. 1) and a communication module 190 (e.g., the communication module 190 of FIG. 1).

According to one or more embodiments, the communication module 190 may receive a communication signal from the outside or transmit a communication signal to the outside based on a Wi-Fi communication scheme (e.g., IEEE 802.11ax). For example, the communication module 190 may operate based on IEEE 802.11ax among Wi-Fi communication schemes and, as compared with IEEE 802.11ac, increase the orthogonal frequency division multiplexing (OFDM) discrete Fourier transform (DFT) period (e.g., 12.8 μs) four times and support 256-medium access control (MAC) protocol data unit (MPDU) aggregation.

According to one or more embodiments, the communication module 190 may include a transceiver 191 for data transmission/reception with an external device and a communication processor 193 (or short-range wireless communication module (e.g., Wi-Fi chipset)). According to one or more embodiments, the communication module 190 may further include a memory.

According to one or more embodiments, the transceiver 191 may convert a baseband transmission signal into a radio signal or convert a received radio signal into a baseband reception signal.

According to one or more embodiments, the communication module 190 may further include components for orthogonal frequency division multiplexing (OFDM) or orthogonal frequency division multiple access (OFDMA), e.g., a modulator, a digital-analog (D/A) converter, a frequency converter, an A/D converter, an amplifier, and/or a demodulator, in addition to the transceiver 191 and the communication processor 193.

According to one or more embodiments, the electronic device may include at least one antenna module (e.g., the antenna module 197 of FIG. 1) that is electrically connected with the communication module of the access point 200 and supports the communication protocol and/or frequency band supported by the communication module of the access point 200.

According to one or more embodiments, the processor 120 may include an application processor. The processor 120 may perform a designated operation of the electronic device 101 or control another piece of hardware (e.g., the communication module 190) to perform a designated operation.

According to one or more embodiments, the communication processor 193 may control the transceiver 191 to form a communication connection (e.g., the first network 198) with the access point 200. For example, the communication connection may include a Wi-Fi network. For example, the communication processor 193 may control the transceiver 191 to form a wireless connection with the access point 200 using IEEE 802.11ac or 802.11ax 2.4 GHz, 5 GHz or 6 GHz band wireless local area network (WLAN) standards. Or, the communication processor 193 may control the transceiver 191 to form a radio connection with the access point 200 using IEEE 802.11ad or 802.11ay 60 GHz band WLAN standards.

According to one or more embodiments, the scheme of performing communication using the wireless local area network (WLAN) standards between the electronic device 101 and the access point 200 may be referred to as a communication scheme based on STA mode.

According to one or more embodiments, the access point 200 may support the operation of transmitting data to an external network and/or receiving data from the external network by a plurality of electronic devices (e.g., the electronic device 101) based on connection between the plurality of electronic devices (e.g., the electronic device 101) and the external network (e.g., Internet, external LAN, or cellular network).

According to one or more embodiments, the access point 200 may be a wireless router. The access point 200 may be a dedicated wireless router or a general-purpose device supporting mobile hotspot, but is not limited in implementation. For example, the access point 200 may include the same components (e.g., a processor (e.g., the processor 120 of FIG. 1) and/or a communication module (e.g., the communication module 190 of FIG. 1)) as the electronic device 101.

According to one or more embodiments, the access point 200 may transmit/receive data to/from an external device, such as a server (e.g., the server 108 or the electronic device 101 of FIG. 1). For example, the access point 200 may transmit at least part of the data received from a server to the electronic device 101. According to one or more embodiments, the access point 200 and the electronic device 101 may transmit/receive uplink (UL)/downlink (DL) data during an operation period. For example, the access point 200 may transmit traffic to the electronic device 101 only during an operation period set based on the schedule information received from the electronic device 101.

According to one or more embodiments, the communication processor 193 may control the transceiver 191 to form a communication connection (e.g., the first network 198 of FIG. 1) with at least one external device 104-1 and/or 104-2 (e.g., the electronic device 104 of FIG. 1) based on neighbor awareness networking (NAN) (or Wi-Fi aware). For example, the electronic device 101 and at least one external device 104-1 and/or 104-2 may form a NAN cluster 20 based on NAN.

According to one or more embodiments, according to the NAN standards, the plurality of electronic devices 101, 104-1, and 104-2 included in the NAN cluster 20 may be time-synchronized between each other, exchanging beacons and service discovery frames within the same discovery window (hereinafter, DW) period.

According to one or more embodiments, the DW is a period (e.g., in milliseconds) during which the electronic device 101 (e.g., the processor 120 or the communication module 190) becomes a wake state and may cause significant current consumption. According to one or more embodiments, the electronic device 101 (e.g., the processor 120 or the communication module 190) may maintain the sleep state during the period other than the DW and may thus perform low-power discovery. Thus, use of NAN allows the electronic device 101 (e.g., the processor 120 or the communication module 190) to consume low current even when remaining in the discovery state and provides advantages in exchanging information between nearby electronic devices, leading to development of various application services.

According to one or more embodiments, the electronic device 101 and the at least one external device 104-1 and/or 104-2 which are time-synchronized may activate the DW at the same time and exchange various NAN action frames (NAF) in the DW. For example, the NAF may include a message for NAN data path (NDP) setup for performing data communication in the period between DWs, a message for updating schedule information, or a message for performing NAN ranging in the fine time measurement (FTM) period.

According to one or more embodiments, if based on the NAN standards, the communication processor 193 may set an additional active time slot in the period between DWs on its own or through a negotiation process with the counterpart electronic device and perform additional communication. For example, the communication processor 193 may additionally perform the service discovery, which has not been performed in the DW, between DWs. For example, the communication processor 193 may designate an operation for WLAN connection or independent basic service set (IBSS), mesh type, or Wi-Fi direct between a DW and the next DW and use it as a process for STA mode Wi-Fi connection or discovery.

According to one or more embodiments, inter-device ranging may be supported through the FTM between the electronic device 101 (e.g., the processor 120 or the communication module 190) and at least one external device 104-1 and/or 104-2 included in the NAN cluster 20. For example, the communication processor 193 may set up a session for NAN ranging in the DW and define an additional time slot between the DW and the next DW to perform ranging with the at least one external device 104-1 and/or 104-2.

According to one or more embodiments, according to the NAN standards, a NAN data path using the period between the DW and the next DW is possible, and the NDP operate on a non-connection basis, so that data communication is possible through a quicker setup as compared with the conventional art, enabling flexible data communication with multiple devices.

According to one or more embodiments, according to the NAN standards, the communication processor 193 may define time slots for data transmission using the period between DWs even without separate connection with at least one external device 104-1 and/or 104-2, and the data transmitted through the NDP may be encrypted.

According to one or more embodiments, the communication processor 193 may control the transceiver 191 to form a communication connection (e.g., the first network 198 of FIG. 1) based on Wi-Fi direct with the external device 106 (e.g., the electronic device 104 of FIG. 1).

According to one or more embodiments, the communication processor 193 may obtain schedule information for concurrently using at least one of the STA mode, NAN, or Wi-Fi direct using information about the NAN cluster 20.

According to one or more embodiments, the communication processor 193 may obtain schedule information by obtaining information about the NAN cluster, which is not included in the electronic device 101, rather than the information about the NAN cluster 20 including the electronic device 101.

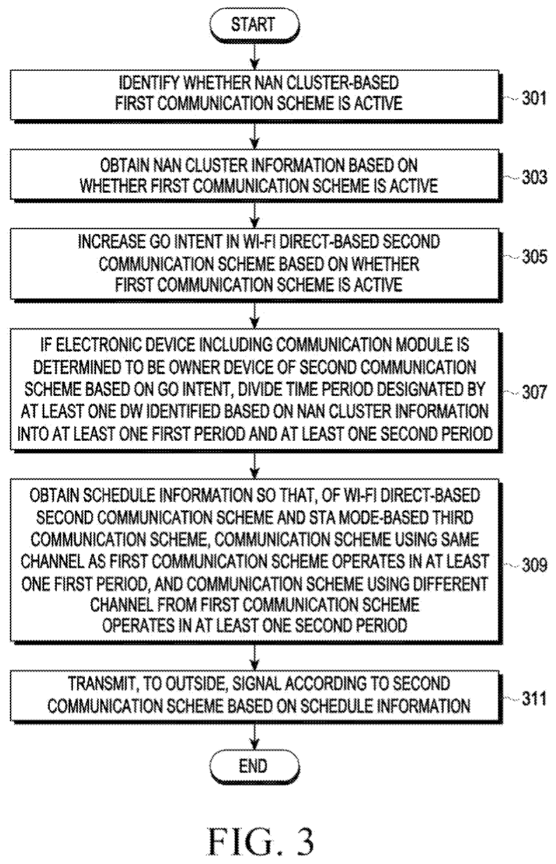

According to one or more embodiments, the operation of obtaining the schedule information by the communication processor 193 is described below with reference to FIGS. 3 to 9.

Although the operation of the communication processor 193 of the communication module 190 has been described above, according to one or more embodiments, the operation of the communication processor 193 may be performed by the processor 120 of the electronic device 101.

FIG. 3 is a view illustrating a control operation of a communication module for using a plurality of communication schemes according to one or more embodiments.

According to one or more embodiments, referring to FIG. 3, in operation 301, the communication processor (e.g., the communication processor 193 of FIG. 2) may identify whether the NAN-based first communication scheme is active or not. For example, if Wi-Fi direct connection is triggered, the communication processor (e.g., the communication processor 193 of FIG. 2) may identify whether the NAN-based communication scheme of the communication module (e.g., the communication module 190 of FIG. 1 or the communication module 190 of FIG. 2) is active. In one embodiment, the communication processor is configured to identify an active state or an inactive state of the NAN-based first communication scheme.

For example, the communication processor (e.g., the communication processor 193 of FIG. 2) may identify whether the communication module (e.g., the communication module 190 of FIG. 1 or the communication module 190 of FIG. 2) is in a state of not supporting the NAN-based communication scheme, in an inactive state in which NAN is supported, but NAN synchronization is not performed, or in an active state of being synchronized with the NAN cluster.

According to one or more embodiments, if in the state in which the NAN-based communication scheme is active, the communication processor (e.g., the communication processor 193 of FIG. 2) may identify whether the communication module (e.g., the communication module 190 of FIG. 1 or the communication module 190 of FIG. 2) is in a state in which the NDP is operated after NAN cluster synchronization.

According to one or more embodiments, in operation 303, the communication processor (e.g., the communication processor 193 of FIG. 2) may obtain NAN cluster information based on whether the NAN-based first communication scheme is active. In one embodiment, the communication processor is configured to obtain NAN cluster information based on the active state of the NAN-based first communication scheme.

For example, the NAN cluster information may include at least one of the ID of the NAN cluster, the length of the time slot, the start time of the DW, the period of the DW, master rank and/or information about whether it is cluster information actually operated or cluster information randomly generated.

According to one or more embodiments, the communication processor (e.g., the communication processor 193 of FIG. 2) may obtain NAN cluster synchronization information, as the NAN cluster information, if the NAN-based communication scheme is in the active state. For example, if the NAN-based communication scheme is in the active state, the communication processor (e.g., the communication processor 193 of FIG. 2) may obtain synchronization information about the NAN cluster including the electronic device (e.g., the electronic device 101 of FIG. 1 or the electronic device 101 of FIG. 2).

As another embodiment, the communication processor (e.g., the communication processor 193 of FIG. 2) may perform a NAN passive scan operation if the NAN-based communication scheme is in the inactive state. For example, the NAN passive scan operation may mean an operation of scanning a beacon signal according to the NAN-based communication scheme, transmitted from the external device. For example, the beacon signal may include information about the NAN cluster including the external device having transmitted the beacon signal.

According to one or more embodiments, upon receiving neighboring NAN cluster information based on the NAN passive scan operation, the communication processor (e.g., the communication processor 193 of FIG. 2) may obtain the received neighboring NAN cluster information as the NAN cluster information.

In one embodiment, upon failing to receive the neighboring NAN cluster information based on the NAN passive scan operation, the communication processor (e.g., the communication processor 193 of FIG. 2) may generate arbitrary NAN cluster information and obtain it as the NAN cluster information.

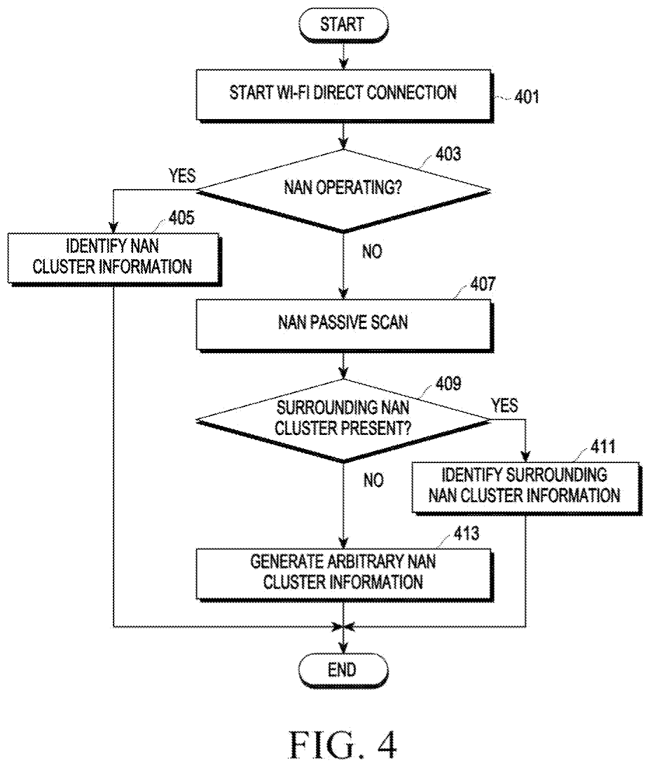

According to one or more embodiments, the operation of obtaining the NAN cluster information by the communication processor (e.g., the communication processor 193 of FIG. 2) is described with reference to FIG. 4.

According to one or more embodiments, when NAN cluster information is stored in the memory (e.g., the memory 130 of FIG. 1) or the memory of the communication module (e.g., the communication module 190 of FIG. 1 or the communication module 190 of FIG. 2), the communication processor (e.g., the communication processor 193 of FIG. 2) may transmit a discovery message to the outside according to Wi-Fi direct-based communication scheme including the stored NAN cluster information. For example, the discovery message may include a probe request signal, probe response signal, or beacon signal in the Wi-Fi direct discovery process.

According to one or more embodiments, the communication processor (e.g., the communication processor 193 of FIG. 2) may receive a response signal to the discovery message and select one piece of NAN cluster information about the transmitted NAN cluster information and the NAN cluster information about the counterpart device included in the response signal. For example, the communication processor (e.g., the communication processor 193 of FIG. 2) may compare the master rank included in the received NAN cluster information and the master rank included in the transmitted NAN cluster information and select the NAN cluster information including the higher master rank.

According to one or more embodiments, the communication processor (e.g., the communication processor 193 of FIG. 2) may store the selected NAN cluster information in the memory (e.g., the memory 130 of FIG. 1) or the memory of the communication module (e.g., the communication module 190 of FIG. 1 or the communication module 190 of FIG. 2).

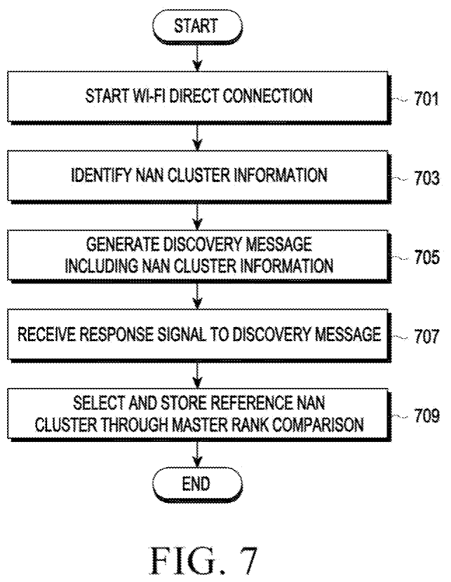

According to one or more embodiments, the operation of obtaining NAN cluster information considering the NAN cluster information about the counterpart device in the Wi-Fi direct-based communication scheme is described with reference to FIG. 7.

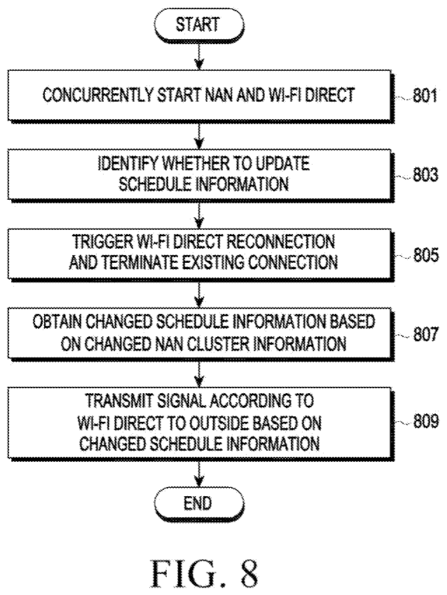

According to one or more embodiments, upon identifying that schedule information needs to be updated while concurrently using the NAN-based communication scheme and the Wi-Fi direct-based communication scheme based on the obtained schedule information, the communication processor (e.g., the communication processor 193 of FIG. 2) may terminate the existing Wi-Fi direct connection and re-perform a new Wi-Fi direct connection. According to one or more embodiments, the Wi-Fi direct reconnection operation is described below with reference to FIG. 8.

According to one or more embodiments, in operation 305, the communication processor (e.g., the communication processor 193 of FIG. 2) may increase the group owner (GO) intent in the Wi-Fi direct-based second communication scheme based on whether the NAN-based first communication scheme is active. In one embodiment, the communication processor is configured to increase the GO intent in the Wi-Fi direct-based second communication scheme, based on the active state of the NAN-based first communication scheme.

For example, the GO intent may mean the value to be the owner device of the group in the Wi-Fi direct-based communication scheme, and a device with a higher GO intent may be determined to be the owner device of the group in the Wi-Fi direct-based communication scheme.

According to one or more embodiments, if the NAN-based communication scheme is in the active state, the communication processor (e.g., the communication processor 193 of FIG. 2) may increase the GO intent by a first value and, if the NAN-based communication scheme is in the inactive state, increase the GO intent by a second value lower than the first value. According to one or more embodiments, the communication processor (e.g., the communication processor 193 of FIG. 2) may adjust the GO intent to the first value if the NAN-based communication scheme is in the active state and adjust the GO intent to the second value lower than the first value if the NAN-based communication scheme is in the inactive state.

For example, when the GO intent is set to the default value, e.g., 6, the communication processor (e.g., the communication processor 193 of FIG. 2) may support the NAN-based communication scheme but, if in the inactive state, increase the GO intent to 9. As another embodiment, if the NAN-based communication scheme is in the active state (e.g., if the NAN-based communication scheme is in a state of being synchronized with the cluster), the communication processor (e.g., the communication processor 193 of FIG. 2) may increase the GO intent to 12.

Thus, the device supporting the NAN-based communication scheme regardless of whether the NAN-based communication scheme is active may obtain a GO intent higher than that of the device not supporting the NAN-based communication scheme and become the owner device in the Wi-Fi direct-based communication scheme. Further, the device in which the NAN-based communication scheme is active may support the NAN-based communication scheme but obtain a higher GO intent than that the device in which it is inactive to become the owner device in the Wi-Fi direct-based communication scheme. As the electronic device (e.g., the electronic device 101 of FIG. 1 or the electronic device 101 of FIG. 2) becomes the owner device in the Wi-Fi direct-based communication scheme, it is possible to generate and/or provide schedule information based on the obtained NAN cluster information.

According to one or more embodiments, the communication processor (e.g., the communication processor 193 of FIG. 2) may increase the GO intent by further considering (or based on) the frequency band of the access point (e.g., the access point 200 of FIG. 2) connected in the STA mode-based communication scheme.

For example, in the state in which the NAN-based communication scheme is supported but is inactive, the communication processor (e.g., the communication processor 193 of FIG. 2) may increase the GO intent to 10 if connected to a 2.4 GHz band access point (e.g., the access point 200 of FIG. 2) in the STA mode-based communication scheme and increase the GO intent to 11 if connected to the 5 GHz band access point (e.g., the access point 200 of FIG. 2) in the STA mode-based communication scheme.

For example, in the state in which the NAN-based communication scheme is active, the communication processor (e.g., the communication processor 193 of FIG. 2) may increase the GO intent to 13 if connected to a 2.4 GHz band access point (e.g., the access point 200 of FIG. 2) in the STA mode-based communication scheme and increase the GO intent to 14 if connected to the 5 GHz band access point (e.g., the access point 200 of FIG. 2) in the STA mode-based communication scheme. The above GO intent values are exemplary, and are not limited thereto.

According to one or more embodiments, in operation 307, if the electronic device (e.g., the electronic device 101 of FIG. 1 or the electronic device 101 of FIG. 2) including the communication module (e.g., the communication module 190 of FIG. 1 or the communication module 190 of FIG. 2) is determined to be the owner device of the second communication scheme based on the GO intent, the communication processor (e.g., the communication processor 193 of FIG. 2) may divide the time period designated by at least one DW identified based on the NAN cluster information (e.g., the NAN cluster information obtained in operation 303) into at least one first period and at least one second period. In one embodiment, the communication processor is configured to determine, based on the GO intent, that the electronic device is a group owner of the Wi-Fi direct-based second communication scheme, and divide a time period into at least one first period and at least one second period. In one embodiment, the time period is designated by a discovery window (DW) identified based on the NAN cluster information.

For example, if becoming the owner device in the Wi-Fi direct-based communication scheme based on the increased GO intent, the communication processor (e.g., the communication processor 193 of FIG. 2) may divide the time period designated by at least one DW identified based on the NAN cluster information into at least one first period and at least one second period.

According to one or more embodiments, the communication processor (e.g., the communication processor 193 of FIG. 2) may divide the time period between the start time of the first DW and the start time of the second DW of the NAN-based communication scheme into at least one first period and at least one second period. According to one or more embodiments, each of the at least one first period and at least one second period may be a multiple of the time slot defined according to the NAN-based communication scheme.

According to one or more embodiments, if the counterpart device has a higher GO intent and is thus determined to be the client device in the Wi-Fi direct-based communication scheme based on the increased GO intent, the communication processor (e.g., the communication processor 193 of FIG. 2) may again increase the GO intent to be higher than the GO intent of the counterpart device or increase the GO intent to the highest value to become the owner device. For example, the communication processor (e.g., the communication processor 193 of FIG. 2) may release the existing connection with the counterpart device and increase the GO intent to perform a connection procedure again to become the owner device. As another embodiment, the communication processor (e.g., the communication processor 193 of FIG. 2) may increase the GO intent in the state of maintaining the existing connection with the counterpart device and again perform a GO negotiation procedure with the counterpart device to become the owner device.

According to one or more embodiments, in operation 309, the communication processor (e.g., the communication processor 193 of FIG. 2) may obtain schedule information so that, of the Wi-Fi direct-based second communication scheme and the STA mode-based third communication scheme, the communication scheme using the same channel as the NAN-based first communication scheme operates in at least one first period, and the communication scheme using a different channel from that of the NAN-based first communication scheme operates in at least one second period. In one embodiment, the communication processor is configured to obtain schedule information indicating that one communication scheme of the Wi-Fi direct-based second communication scheme and a STA mode-based third communication scheme operates in the at least one first period, and the other communication scheme of the Wi-Fi direct-based second communication scheme and the STA mode-based third communication scheme operates in the at least one second period. In one embodiment, the one communication scheme uses a same channel with the NAN-based first communication scheme and the other communication scheme uses a different channel than the NAN-based first communication scheme.

For example, the communication processor (e.g., the communication processor 193 of FIG. 2) may obtain schedule information so that the Wi-Fi direct-based communication scheme using the same channel as the NAN-based communication scheme operates in at least one first period where the NAN-based communication scheme is active, and the STA mode-based communication scheme using a different channel from that of the NAN-based communication scheme operates in at least one second period where the NAN-based communication scheme is inactive.

According to another embodiment, when the STA mode-based communication scheme uses the same channel as the NAN-based communication scheme, the communication processor (e.g., the communication processor 193 of FIG. 2) may obtain schedule information so that the STA mode-based communication scheme using the same channel as the NAN-based communication scheme operates in at least one first period where the NAN-based communication scheme is active, and the NAN-based communication scheme using a different channel from that of the NAN-based communication scheme operates in at least one second period where the NAN-based communication scheme is inactive.

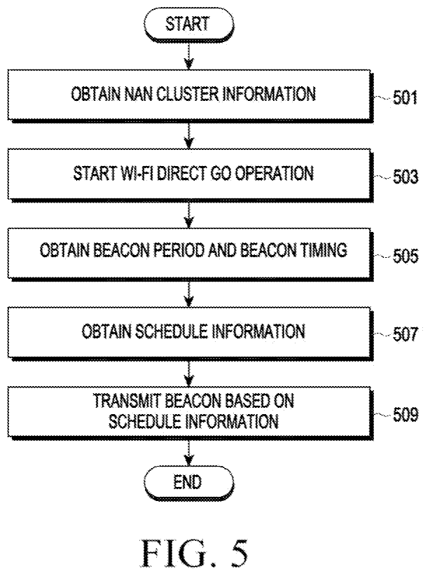

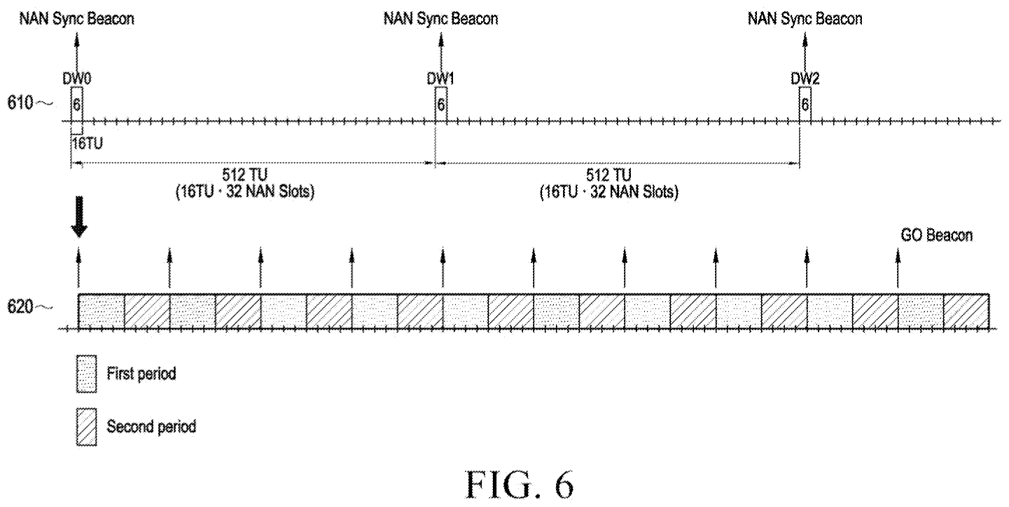

According to one or more embodiments, the operation of obtaining schedule information by the communication processor (e.g., the communication processor 193 of FIG. 2) is described below with reference to FIGS. 5 and 6.

According to one or more embodiments, in operation 311, the communication processor (e.g., the communication processor 193 of FIG. 2) may transmit a signal according to the second communication scheme to the outside based on schedule information. In one embodiment, the transceiver is configured to transmit a signal according to the Wi-Fi direct-based second communication scheme, to an outside of the electronic device, based on the schedule information.

For example, the communication processor (e.g., the communication processor 193 of FIG. 2) may transmit a beacon signal according to the Wi-Fi direct scheme to the outside through the transceiver (e.g., the transceiver 191 of FIG. 2). According to one or more embodiments, the beacon signal according to the Wi-Fi direct-based communication scheme may include the obtained schedule information.

For example, when the Wi-Fi direct-based communication scheme uses the same channel as the NAN-based communication scheme, the communication processor (e.g., the communication processor 193 of FIG. 2) may transmit a signal according to the Wi-Fi direct-based communication scheme in at least one first period.

According to another embodiment, when the STA mode-based communication scheme uses the same channel as the NAN-based communication scheme, the communication processor (e.g., the communication processor 193 of FIG. 2) may transmit a signal according to the Wi-Fi direct-based communication scheme in at least one second period. According to one or more embodiments, the beacon signal according to the Wi-Fi direct-based communication scheme may include the obtained schedule information.

According to one or more embodiments, the communication processor (e.g., the communication processor 193 of FIG. 2) may perform time clock-synchronization on the NAN-based communication scheme, Wi-Fi direct-based communication scheme, and STA mode-based communication scheme before obtaining the schedule information. For example, the communication processor (e.g., the communication processor 193 of FIG. 2) may time-synchronize the plurality of Wi-Fi-based communications before operation 301 or after operation 301 and before operation 309.

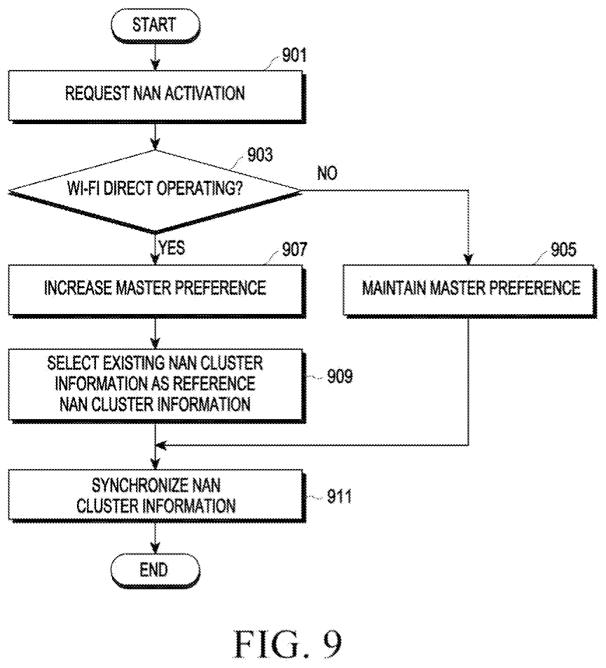

According to one or more embodiments, if the NAN-based communication scheme is activated, and another activated NAN cluster is detected while operating in the Wi-Fi direct-based communication scheme according to the obtained schedule information, the communication processor (e.g., the communication processor 193 of FIG. 2) may set the master rank of the NAN cluster information to the maximum value. The operation of the communication processor (e.g., the communication processor 193 of FIG. 2) when the NAN-based communication scheme is activated while operating in the Wi-Fi direct-based communication scheme is described with reference to FIG. 9.

Although the operation is described as performed by the communication processor (e.g., the communication processor 193 of FIG. 2) of the communication module (e.g., the communication module 190 of FIG. 1 or the communication module 190 of FIG. 2), according to one or more embodiments, the operation of the communication processor (e.g., the communication processor 193 of FIG. 2) may be performed by the processor (e.g., the processor 120 of FIG. 1 or the processor 120 of FIG. 2) of the electronic device (e.g., the electronic device 101 of FIG. 1 or the electronic device 101 of FIG. 2).

FIG. 4 is a view illustrating an operation of obtaining NAN cluster information about a communication module according to one or more embodiments.

According to one or more embodiments, referring to FIG. 4, in operation 401, the communication processor (e.g., the communication processor 193 of FIG. 2) may start a Wi-Fi direct connection. For example, if the Wi-Fi direct connection is triggered by the user or an application, the communication processor (e.g., the communication processor 193 of FIG. 2) may start a Wi-Fi direct connection.

According to one or more embodiments, in operation 403, the communication processor (e.g., the communication processor 193 of FIG. 2) may identify whether NAN operation is in progress. For example, the communication processor (e.g., the communication processor 193 of FIG. 2) may identify whether the communication module (e.g., the communication module 190 of FIG. 1 or the communication module 190 of FIG. 2) operates in the NAN-based communication scheme, synchronized with the NAN cluster.

According to one or more embodiments, upon identifying that the NAN operation is in progress (yes in operation 403), the communication processor (e.g., the communication processor 193 of FIG. 2) may identify NAN cluster information in operation 405. According to one or more embodiments, the communication processor (e.g., the communication processor 193 of FIG. 2) may obtain NAN cluster synchronization information as the NAN cluster information. For example, if the NAN-based communication scheme is in the active state, the communication processor (e.g., the communication processor 193 of FIG. 2) may obtain synchronization information about the NAN cluster including the electronic device (e.g., the electronic device 101 of FIG. 1 or the electronic device 101 of FIG. 2), and the NAN cluster information.

According to one or more embodiments, upon identifying that the NAN operation is not in progress (no in operation 403), the communication processor (e.g., the communication processor 193 of FIG. 2) may perform a NAN passive scan operation in operation 407. For example, the communication processor (e.g., the communication processor 193 of FIG. 2) may perform a NAN passive scan operation if the NAN-based communication scheme is in the inactive state. For example, the NAN passive scan operation may mean the operation of scanning a beacon signal (e.g., NAN discovery beacon signal) according to the NAN-based communication scheme, transmitted from an external device (e.g., the master device of the neighboring NAN cluster) and be performed during or before the Wi-Fi direct discovery. For example, the beacon signal may include information about the NAN cluster including the external device having transmitted the beacon signal.

According to one or more embodiments, the NAN passive scan operation may be performed along with the Wi-Fi direct discovery. As another embodiment, the NAN passive scan operation may be performed, and the Wi-Fi direct discovery may then be performed.

According to one or more embodiments, in operation 409, the communication processor (e.g., the communication processor 193 of FIG. 2) may identify whether there is a neighboring NAN cluster. For example, upon receiving a NAN discovery beacon signal, the communication processor (e.g., the communication processor 193 of FIG. 2) may identify that there is a neighboring NAN cluster.

According to one or more embodiments, if it is identified that there is a neighboring NAN cluster (yes in operation 409), upon receiving neighboring NAN cluster information based on the NAN passive scan operation, the communication processor (e.g., the communication processor 193 of FIG. 2) may obtain the received neighboring NAN cluster information as the NAN cluster information.

As another embodiment, upon identifying that there is no NAN cluster (no in operation 409), the communication processor (e.g., the communication processor 193 of FIG. 2) may generate arbitrary NAN cluster information in operation 413.

According to one or more embodiments, the communication processor (e.g., the communication processor 193 of FIG. 2) may store the generated NAN cluster information in the memory (e.g., the memory 130 of FIG. 1) or the memory of the communication module (e.g., the communication module 190 of FIG. 1 or the communication module 190 of FIG. 2).

According to one or more embodiments, the communication processor (e.g., the communication processor 193 of FIG. 2) may adjust the GO intent in the Wi-Fi direct-based communication scheme based on the obtained NAN cluster information or obtain schedule information for using a plurality of Wi-Fi-based connection schemes.

Although the operation is described as performed by the communication processor (e.g., the communication processor 193 of FIG. 2) of the communication module (e.g., the communication module 190 of FIG. 1 or the communication module 190 of FIG. 2), according to one or more embodiments, the operation of the communication processor (e.g., the communication processor 193 of FIG. 2) may be performed by the processor (e.g., the processor 120 of FIG. 1 or the processor 120 of FIG. 2) of the electronic device (e.g., the electronic device 101 of FIG. 1 or the electronic device 101 of FIG. 2).

FIG. 5 is a view illustrating an operation of obtaining schedule information for using a plurality of communication schemes of a communication module according to one or more embodiments.

According to one or more embodiments, in operation 501, the communication processor (e.g., the communication processor 193 of FIG. 2) may obtain NAN cluster information. For example, the communication processor (e.g., the communication processor 193 of FIG. 2) may obtain NAN cluster information based on the operations shown in FIG. 4.

According to one or more embodiments, the communication processor (e.g., the communication processor 193 of FIG. 2) may obtain NAN cluster information considering the NAN cluster information about the counterpart device in the Wi-Fi direct-based communication scheme as shown in FIG. 7 or obtain NAN cluster information changed according to NAN cluster merging as shown in FIG. 8. This is described below in further detail with reference to FIGS. 7 and 8.

According to one or more embodiments, in operation 503, the communication processor (e.g., the communication processor 193 of FIG. 2) may start a GO operation based on Wi-Fi direct. For example, if determined to be the owner device of the Wi-Fi direct-based communication scheme group based on the increased GO intent according to operation 305 of FIG. 3, the communication processor (e.g., the communication processor 193 of FIG. 2) may start a group owner (GO) operation. For example, the GO operation may include the operation of obtaining schedule information for concurrent use of a plurality of Wi-Fi-based communication schemes based on the obtained NAN cluster information.

According to one or more embodiments, in operation 505, the communication processor (e.g., the communication processor 193 of FIG. 2) may obtain a beacon period and a beacon timing.

According to one or more embodiments, the communication processor (e.g., the communication processor 193 of FIG. 2) may determine a beacon signal interval of the Wi-Fi direct-based communication scheme as a multiple of the time slot defined according to the NAN-based communication scheme based on the NAN cluster information.

FIG. 6 is a view illustrating schedule information obtained to use a plurality of communication schemes according to one or more embodiments.

For example, the communication processor (e.g., the communication processor 193 of FIG. 2) may determine eight time slots of the NAN-based communication scheme as the interval of the Wi-Fi direct-based communication scheme based on the NAN cluster information 610 as shown in FIG. 6 and transmit a Wi-Fi direct-based communication scheme beacon signal at the timing synchronized with the NAN-based communication scheme. According to one or more embodiments, the number of NAN-based communication scheme time slots used to determine the beacon signal interval is not limited thereto.

According to one or more embodiments, the beacon signal interval of the Wi-Fi direct-based communication scheme may be determined based on the start time or end time of the NAN-based communication scheme discovery window (DW). For example, as shown in FIG. 6, the communication processor (e.g., the communication processor 193 of FIG. 2) may divide the time period between the first DW (e.g., DW0) and the next DW, i.e., second DW (e.g., DW1) into a plurality of periods based on the respective start times or respective end times of the first DW (e.g., DW0) and the next DW, i.e., the second DW (e.g., DW1), based on the NAN cluster information 610 and determine the Wi-Fi direct-based communication scheme beacon signal interval based on each divided period.

Referring to FIG. 6, according to one or more embodiments, the communication processor (e.g., the communication processor 193 of FIG. 2) may transmit a signal (e.g., sync beacon) according to the NAN-based communication scheme in the DW period, and the direct-based communication scheme beacon signal may also be transmitted at the timing synchronized with the NAN-based communication scheme.

According to one or more embodiments, in operation 507, the communication processor (e.g., the communication processor 193 of FIG. 2) may obtain schedule information.

According to one or more embodiments, the communication processor (e.g., the communication processor 193 of FIG. 2) may divide the time period designated by at least one DW identified based on the NAN cluster information into at least one first period and at least one second period. For example, the communication processor (e.g., the communication processor 193 of FIG. 2) may divide the period where the NAN-based communication scheme is activated as the first period, and the period where the NAN-based communication scheme is inactivated as the second period.

For example, referring to FIG. 6, the communication processor (e.g., the communication processor 193 of FIG. 2) may divide the time period between the first DW (e.g., DW0) and the next DW, i.e., the second DW (e.g., DW1) into at least one first period and at least one second period. For example, referring to the schedule information 620 for use of a plurality of Wi-Fi-based communication schemes shown in FIG. 6, the communication processor (e.g., the communication processor 193 of FIG. 2) may divide into the first period and second period, as the half (e.g., four time slots) of the Wi-Fi direct-based beacon signal interval (e.g., eight time slots).

According to one or more embodiments, when at least two or more of the NAN-based communication scheme, the Wi-Fi direct-based communication scheme, or the STA mode-based communication scheme are not concurrently used, at least one of the first period or second period of the schedule information 620 may be a potential period which is not used for Wi-Fi-based communication.

According to one or more embodiments, the communication processor (e.g., the communication processor 193 of FIG. 2) may obtain schedule information 620 so that, of the Wi-Fi direct-based second communication scheme and the STA mode-based third communication scheme, the communication scheme using the same channel as the NAN-based first communication scheme operates in at least one first period, and the communication scheme using a different channel from that of the NAN-based first communication scheme operates in at least one second period.

For example, the communication processor (e.g., the communication processor 193 of FIG. 2) may obtain schedule information so that the Wi-Fi direct-based communication scheme using the same channel as the NAN-based communication scheme operates in at least one first period where the NAN-based communication scheme is active, and the STA mode-based communication scheme using a different channel from that of the NAN-based communication scheme operates in at least one second period where the NAN-based communication scheme is inactive.

According to another embodiment, when the STA mode-based communication scheme uses the same channel as the NAN-based communication scheme, the communication processor (e.g., the communication processor 193 of FIG. 2) may obtain schedule information so that the STA mode-based communication scheme using the same channel as the NAN-based communication scheme operates in at least one first period where the NAN-based communication scheme is active, and the NAN-based communication scheme using a different channel from that of the NAN-based communication scheme operates in at least one second period where the NAN-based communication scheme is inactive.

According to one or more embodiments, in a case where the communication processor (e.g., the communication processor 193 of FIG. 2) concurrently supports different frequency bands, if the channel of the frequency band operating the DW period is a channel of a different frequency band from the frequency band in which the first period or second period operates the DW period, schedule information in which the DW period overlaps part of the first period or second period may be obtained. As another embodiment, when the communication processor (e.g., the communication processor 193 of FIG. 2) does not concurrently support different frequency bands, schedule information in which the first period or second period does not overlap during the DW period may be obtained.

According to one or more embodiments, in operation 509, the communication processor (e.g., the communication processor 193 of FIG. 2) may transmit a beacon based on the schedule information 620. For example, when the Wi-Fi direct-based communication scheme uses the same channel as the NAN-based communication scheme, the communication processor (e.g., the communication processor 193 of FIG. 2) may transmit a signal (e.g., beacon signal) according to the Wi-Fi direct-based communication scheme in at least one first period.

According to another embodiment, when the STA mode-based communication scheme uses the same channel as the NAN-based communication scheme, the communication processor (e.g., the communication processor 193 of FIG. 2) may transmit a signal according to the Wi-Fi direct-based communication scheme in at least one second period. According to one or more embodiments, the beacon signal according to the Wi-Fi direct-based communication scheme may include the obtained schedule information 620.

Although the operation is described as performed by the communication processor (e.g., the communication processor 193 of FIG. 2) of the communication module (e.g., the communication module 190 of FIG. 1 or the communication module 190 of FIG. 2), according to one or more embodiments, the operation of the communication processor (e.g., the communication processor 193 of FIG. 2) may be performed by the processor (e.g., the processor 120 of FIG. 1 or the processor 120 of FIG. 2) of the electronic device (e.g., the electronic device 101 of FIG. 1 or the electronic device 101 of FIG. 2).

FIG. 7 is a view illustrating an operation of obtaining NAN cluster information about a communication module according to one or more embodiments. For example, FIG. 7 is a view illustrating the operation of obtaining NAN cluster information for use in schedule information when performing Wi-Fi direct-based communication connection with the counterpart device which is based on Wi-Fi direct.

According to one or more embodiments, referring to FIG. 7, in operation 701, the communication processor (e.g., the communication processor 193 of FIG. 2) may start a Wi-Fi direct connection. For example, if the Wi-Fi direct connection is triggered by the user or an application, the communication processor (e.g., the communication processor 193 of FIG. 2) may start a Wi-Fi direct connection.

According to one or more embodiments, in operation 703, the communication processor (e.g., the communication processor 193 of FIG. 2) may identify NAN cluster information. For example, the communication processor (e.g., the communication processor 193 of FIG. 2) may identify NAN cluster information based on the operations shown in FIG. 4.

According to one or more embodiments, in operation 705, the communication processor (e.g., the communication processor 193 of FIG. 2) may generate a discovery message including NAN cluster information.

According to one or more embodiments, the NAN cluster information may include a probe request signal, a probe response signal, or a beacon signal of the Wi-Fi direct discovery process, in the form of cluster discovery attribute information.

For example, the cluster discovery attribute information is defined as transmitted by including the NAN cluster information in the discovery message through a communication scheme other than the NAN-based communication scheme, as a field defined in the NAN standards, as shown in Table 1 below.

According to one or more embodiments, the discovery attribute information may include the cluster ID, TSF offset of the NAN cluster and the corresponding Wi-Fi standard, and master rank of cluster as shown in Table 1 below.

TABLE 1

| Field | Size (Octets) | Value | Description |
|---|---|---|---|
| Attribute ID | 1 | 0x0D | Identifies the type of NAN attribute |
| Length | 2 | Variable | Length of the following fields in the |
| | | | attribute |
| Cluster ID | 6 | Variable | NAN Cluster ID |
| Cluster Time Offset | 8 | Variable | 2's complement representation of the |
| | | | signed difference between the sender's |
| | | | TSF and the NAN TSF |
| Anchor Master Rank | 9 | Variable | Rank of the Anchor Master of the NAN |
| | | | whose Cluster ID is indicated in the |
| | | | attribute. Refer to the Master Rank |
| | | | definition in section 3.3.3 |

According to one or more embodiments, in operation 707, the communication processor (e.g., the communication processor 193 of FIG. 2) may receive a response signal to the discovery message. According to one or more embodiments, the communication processor (e.g., the communication processor 193 of FIG. 2) may obtain NAN cluster information included in the response signal to transmission of the discovery message. For example, the response signal to transmission of the discovery message may be transmitted from a device discovered through the Wi-Fi direct discovery, and the NAN cluster information included in the response signal may be NAN cluster information used by the discovered device.

According to one or more embodiments, in operation 709, the communication processor (e.g., the communication processor 193 of FIG. 2) may select and store reference NAN cluster information through master rank comparison. For example, the reference NAN cluster information may mean NAN cluster information to be used in the schedule information for concurrent use of a plurality of Wi-Fi-based communication schemes.

According to one or more embodiments, the communication processor (e.g., the communication processor 193 of FIG. 2) may compare the NAN cluster information identified in operation 703 and the NAN cluster information received in operation 707, selecting one NAN cluster information. For example, the communication processor (e.g., the communication processor 193 of FIG. 2) may compare the master rank included in the NAN cluster information identified in operation 703 and the master rank included in the NAN cluster information received in operation 707, selecting the NAN cluster information having the higher master rank.

According to one or more embodiments, the communication processor (e.g., the communication processor 193 of FIG. 2) may compare the ID of the NAN cluster information identified in operation 703 and the ID of the NAN cluster information received in operation 707 and, if the NAN cluster information IDs differ, select the NAN cluster information having the higher master rank. As another embodiment, if the NAN cluster information IDs are the same, the communication processor (e.g., the communication processor 193 of FIG. 2) may select the NAN cluster information identified in operation 703.

According to one or more embodiments, the communication processor (e.g., the communication processor 193 of FIG. 2) may store the selected NAN cluster information in the memory (e.g., the memory 130 of FIG. 1) or the memory of the communication module (e.g., the communication module 190 of FIG. 1 or the communication module 190 of FIG. 2).

As such, if two devices included in the Wi-Fi direct-based communication scheme group synchronize NAN cluster information, whichever device determined to be the owner device may generate schedule information using the NAN cluster information according to the disclosure.

Although the operation is described as performed by the communication processor (e.g., the communication processor 193 of FIG. 2) of the communication module (e.g., the communication module 190 of FIG. 1 or the communication module 190 of FIG. 2), according to one or more embodiments, the operation of the communication processor (e.g., the communication processor 193 of FIG. 2) may be performed by the processor (e.g., the processor 120 of FIG. 1 or the processor 120 of FIG. 2) of the electronic device (e.g., the electronic device 101 of FIG. 1 or the electronic device 101 of FIG. 2).

FIG. 8 is a view illustrating a reconnection operation in a Wi-Fi scheme of a communication module according to one or more embodiments. For example, FIG. 8 is a view illustrating the operation of the communication processor (e.g., the communication processor 193 of FIG. 2) when the NAN cluster information is changed, or the GO intent of the electronic device (e.g., the electronic device 101 of FIG. 1 or the electronic device 101 of FIG. 2) is lower than that of the counterpart device of the Wi-Fi direct-based communication scheme group.

According to one or more embodiments, referring to FIG. 8, in operation 801, the communication processor (e.g., the communication processor 193 of FIG. 2) may operate concurrently in the NAN-based communication scheme and the Wi-Fi direct-based communication scheme.

According to one or more embodiments, in operation 803, the communication processor (e.g., the communication processor 193 of FIG. 2) may identify whether schedule information is updated. For example, if the Wi-Fi direct-based communication scheme timing is not synchronized from the NAN-based communication scheme timing while the Wi-Fi direct-based communication scheme and the NAN-based communication scheme are concurrently used as shown in FIG. 6, the communication processor (e.g., the communication processor 193 of FIG. 2) may identify that the schedule information needs to be updated.

For example, if the NAN cluster information is changed into other NAN cluster information having a higher master rank based on merging with another NAN cluster, the communication processor (e.g., the communication processor 193 of FIG. 2) may identify that the schedule information needs to be updated.

According to one or more embodiments, if determined to be the client device when connected with the external device in the Wi-Fi direct-based communication scheme, since the counterpart does not consider the NAN cluster information about the electronic device (e.g., the electronic device 101 of FIG. 1 or the electronic device 101 of FIG. 2), the communication processor (e.g., the communication processor 193 of FIG. 2) may identify that the schedule information needs to be updated if the Wi-Fi direct-based communication scheme timing and the NAN-based communication scheme timing are not synchronized from each other.

According to one or more embodiments, in operation 805, the communication processor (e.g., the communication processor 193 of FIG. 2) may trigger reconnection and terminate the existing connection to update the Wi-Fi direct operation timing.

According to one or more embodiments, in operation 807, the communication processor (e.g., the communication processor 193 of FIG. 2) may obtain schedule information changed based on the changed NAN cluster information.

According to one or more embodiments, if determined to be the client device when connected with the external device in the Wi-Fi direct-based communication scheme, the communication processor (e.g., the communication processor 193 of FIG. 2) may increase the GO intent to be higher than that of the counterpart device or increase the GO intent to the maximum value. According to one or more embodiments, the communication processor (e.g., the communication processor 193 of FIG. 2) may be determined to be the owner device according to the Wi-Fi direct-based communication scheme, based on the increased GO intent. For example, the communication processor (e.g., the communication processor 193 of FIG. 2) may be determined to be the owner device by performing GO negotiation with the counterpart device based on the increased GO intent and enable the counterpart device to operate as the client device.

As another embodiment, if determined to be the client device when connected with the external device in the Wi-Fi direct-based communication scheme, the communication processor (e.g., the communication processor 193 of FIG. 2) may be determined to be the owner device without GO negotiation with the counterpart device through the autonomous GO mode and enable the counterpart device to operate as the client device.

According to one or more embodiments, in operation 809, the communication processor (e.g., the communication processor 193 of FIG. 2) may transmit a signal according to the Wi-Fi direct-based communication scheme to the outside, based on the changed schedule information. According to one or more embodiments, the signal according to the Wi-Fi direct-based communication scheme may include the obtained schedule information.

Although the operation is described as performed by the communication processor (e.g., the communication processor 193 of FIG. 2) of the communication module (e.g., the communication module 190 of FIG. 1 or the communication module 190 of FIG. 2), according to one or more embodiments, the operation of the communication processor (e.g., the communication processor 193 of FIG. 2) may be performed by the processor (e.g., the processor 120 of FIG. 1 or the processor 120 of FIG. 2) of the electronic device (e.g., the electronic device 101 of FIG. 1 or the electronic device 101 of FIG. 2).

FIG. 9 is a view illustrating operations of a communication module when a NAN cluster is activated while a communication module operates in a Wi-Fi direct scheme according to one or more embodiments.

According to one or more embodiments, referring to FIG. 9, in operation 901, the communication processor (e.g., the communication processor 193 of FIG. 2) may receive a NAN activation request.

According to one or more embodiments, in operation 903, the communication processor (e.g., the communication processor 193 of FIG. 2) may determine whether it operates in the Wi-Fi direct-based communication scheme. For example, the communication processor (e.g., the communication processor 193 of FIG. 2) may determine whether it performs Wi-Fi direct-based communication based on the schedule information 620 using the NAN cluster information of FIG. 6.

According to one or more embodiments, if not operating in the Wi-Fi direct-based communication scheme (no in operation 903), the communication processor (e.g., the communication processor 193 of FIG. 2) may maintain master preference (or master rank) in operation 905.

According to one or more embodiments, if operating in the Wi-Fi direct-based communication scheme (yes in operation 903), the communication processor (e.g., the communication processor 193 of FIG. 2) may increase the master preference (or master rank) in operation 907. For example, in a case where the NAN-based communication scheme of the communication processor (e.g., the communication processor 193 of FIG. 2) is activated, if a NAN cluster operating in high master preference is operating around, it may be synchronized with the neighboring NAN cluster information, so that the communication processor (e.g., the communication processor 193 of FIG. 2) may increase the master preference (or master rank). For example, the communication processor (e.g., the communication processor 193 of FIG. 2) may increase the master preference (or master rank) to the maximum value (e.g., 128 or more).

According to one or more embodiments, in operation 909, the communication processor (e.g., the communication processor 193 of FIG. 2) may select the existing NAN cluster information as reference NAN cluster information.

According to one or more embodiments, in operation 911, the communication processor (e.g., the communication processor 193 of FIG. 2) may synchronize NAN cluster information. For example, the communication processor (e.g., the communication processor 193 of FIG. 2) may synchronize the neighboring NAN cluster information as the selected reference NAN cluster information.

Thus, the existing schedule information may be maintained.

Although the operation is described as performed by the communication processor (e.g., the communication processor 193 of FIG. 2) of the communication module (e.g., the communication module 190 of FIG. 1 or the communication module 190 of FIG. 2), according to one or more embodiments, the operation of the communication processor (e.g., the communication processor 193 of FIG. 2) may be performed by the processor (e.g., the processor 120 of FIG. 1 or the processor 120 of FIG. 2) of the electronic device (e.g., the electronic device 101 of FIG. 1 or the electronic device 101 of FIG. 2).

According to one or more embodiments, a communication module may comprise a transceiver and a communication processor operatively connected with the transceiver. The communication processor may be configured to identify whether a neighbor awareness networking (NAN)-based first communication scheme is active, obtain NAN cluster information based on whether the first communication scheme is active, increase a group owner (GO) intent in a Wi-Fi direct-based second communication scheme based on whether the first communication scheme is active, if an electronic device including the communication module is determined to be an owner device of the second communication scheme based on the increased value, divide a time period designated by a discovery window (DW) identified based on the NAN cluster information into at least one first period and at least one second period, obtain schedule information so that, of the second communication scheme and an STA mode-based third communication scheme, a communication scheme using the same channel as the first communication scheme operates in the at least one first period, and a communication scheme using a different channel from the first communication scheme operates in the at least one second period, and transmit a signal according to the second communication scheme to an outside through the transceiver, based on the schedule information.

According to one or more embodiments, the signal according to the second communication scheme may be a beacon signal of the second communication scheme including the schedule information.

According to one or more embodiments, the communication processor may be configured to transmit the signal according to the second communication scheme in the at least one first period.

According to one or more embodiments, the communication processor may be configured to divide a time period between a start time of a first DW and a start time of a second DW into the at least one first period and the at least one second period. Each of the at least one first period and the at least one second period may be a multiple of a time slot defined according to the NAN-based first communication scheme.

According to one or more embodiments, the communication processor may be configured to obtain NAN cluster synchronization information as the NAN cluster information if the first communication scheme is in an active state, perform a NAN passive scan operation if the first communication scheme is in an inactive state, if neighboring NAN cluster information is received based on the NAN passive scan operation, obtain the received neighboring NAN cluster information as the NAN cluster information, and if the neighboring NAN cluster information is not received based on the NAN passive scan operation, generate arbitrary NAN cluster information.

According to one or more embodiments, the communication processor may be configured to increase the GO intent by a first value if the first communication scheme is in an active state and increase the GO intent by a second value lower than the first value if the first communication scheme is in an inactive state.

According to one or more embodiments, the communication processor may be configured to increase the GO intent further considering a frequency band of an access point connected in the third communication scheme.

According to one or more embodiments, the communication processor may be configured to obtain the schedule information after performing time synchronization on the first communication scheme, the second communication scheme, and the third communication scheme.

According to one or more embodiments, the communication module may further comprise a memory. The communication processor may be configured to transmit, to the outside, a discovery message of the second communication scheme including NAN cluster information stored in the memory, receive a response signal to the discovery message, and obtain one having a higher master rank of NAN cluster information about a counterpart device included in the response signal and the transmitted NAN cluster information, as the NAN cluster information.

According to one or more embodiments, the communication processor may be configured to, if the NAN cluster information is changed into information about another NAN cluster based on merging with the other NAN cluster, obtain schedule information changed based on the changed NAN cluster information and transmit a signal according to the second communication scheme to the outside through the transceiver, based on the changed schedule information.

According to one or more embodiments, the communication processor may be configured to, if the first communication scheme is activated while operating in the second communication scheme, and another activated NAN cluster is detected, set a master rank of the NAN cluster information to a maximum value.

According to one or more embodiments, a method for controlling a communication module may comprise identifying whether a neighbor awareness networking (NAN)-based first communication scheme is active, obtaining NAN cluster information based on whether the first communication scheme is active, increasing a group owner (GO) intent in a Wi-Fi direct-based second communication scheme based on whether the first communication scheme is active, if an electronic device including the communication module is determined to be an owner device of the second communication scheme based on the increased value, dividing a time period designated by a discovery window (DW) identified based on the NAN cluster information into at least one first period and at least one second period, obtaining schedule information so that, of the second communication scheme and an STA mode-based third communication scheme, a communication scheme using the same channel as the first communication scheme operates in the at least one first period, and a communication scheme using a different channel from the first communication scheme operates in the at least one second period, and transmitting a signal according to the second communication scheme to an outside, based on the schedule information.

According to one or more embodiments, the signal according to the second communication scheme may be a beacon signal of the second communication scheme including the schedule information.

According to one or more embodiments, the transmitting may transmit the signal according to the second communication scheme in the at least one first period.

According to one or more embodiments, the dividing may divide a time period between a start time of a first DW and a start time of a second DW into the at least one first period and the at least one second period. Each of the at least one first period and the at least one second period may be a multiple of a time slot defined according to the NAN-based first communication scheme.

According to one or more embodiments, the method for obtaining the NAN cluster information may obtain NAN cluster synchronization information as the NAN cluster information if the first communication scheme is in an active state, perform a NAN passive scan operation if the first communication scheme is in an inactive state, if neighboring NAN cluster information is received based on the NAN passive scan operation, obtain the received neighboring NAN cluster information as the NAN cluster information, and if the neighboring NAN cluster information is not received based on the NAN passive scan operation, generate arbitrary NAN cluster information.

According to one or more embodiments, increasing the GO intent may increase the GO intent by a first value if the first communication scheme is in an active state and increase the GO intent by a second value lower than the first value if the first communication scheme is in an inactive state.

According to one or more embodiments, increasing the GO intent may increase the GO intent further considering a frequency band of an access point connected in the third communication scheme.

According to one or more embodiments, the method for controlling the communication module may further include performing time synchronization on the first communication scheme, the second communication scheme, and the third communication scheme before obtaining the schedule information.

According to one or more embodiments, an electronic device may comprise a communication module and a processor operatively connected with the communication module. The processor may be configured to identify whether a neighbor awareness networking (NAN)-based first communication scheme is active, obtain NAN cluster information based on whether the first communication scheme is active, increase a group owner (GO) intent in a Wi-Fi direct-based second communication scheme based on whether the first communication scheme is active, if an electronic device including the communication module is determined to be an owner device of the second communication scheme based on the increased value, divide a time period designated by a discovery window (DW) identified based on the NAN cluster information into at least one first period and at least one second period, obtain schedule information so that, of the second communication scheme and an STA mode-based third communication scheme, a communication scheme using the same channel as the first communication scheme operates in the at least one first period, and a communication scheme using a different channel from the first communication scheme operates in the at least one second period, and transmit a signal according to the second communication scheme to an outside through the communication module, based on the schedule information.

The electronic device according to various embodiments of the disclosure may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program products may be traded as commodities between sellers and buyers. The computer program product may be distributed in the form of a machine-readable storage medium (e.g., compact disc read only memory (CD-ROM)), or be distributed (e.g., downloaded or uploaded) online via an application store (e.g., Play Store™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities. Some of the plurality of entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

What is claimed is:

1. An electronic device comprising:
a transceiver; and
a communication processor operatively connected with the transceiver,
wherein the communication processor is configured to:
identify whether a neighbor awareness networking (NAN)-based first communication scheme is in an active state or an inactive state;
based on the NAN-based first communication scheme being in the active state, obtain NAN cluster information;
based on the NAN-based first communication scheme being in the active state, increase a group owner (GO) intent in a Wi-Fi direct-based second communication scheme;
determine, based on the GO intent, that the electronic device is a group owner of the Wi-Fi direct-based second communication scheme, and divide a time period into at least one first period and at least one second period, the time period is being designated by a discovery window (DW) identified based on the NAN cluster information;
obtain schedule information indicating that one communication scheme from among the Wi-Fi direct-based second communication scheme and a STA mode-based third communication scheme operates in the at least one first period, and the other communication scheme from among the Wi-Fi direct-based second communication scheme and the STA mode-based third communication scheme operates in the at least one second period, wherein the one communication scheme uses a same channel as the NAN-based first communication scheme and the other communication scheme uses a different channel than the NAN-based first communication scheme; and
control the transceiver to transmit a signal according to the Wi-Fi direct-based second communication scheme, based on the schedule information.

2. The electronic device of claim 1, wherein the signal according to the Wi-Fi direct-based second communication scheme is a beacon signal of the Wi-Fi direct-based second communication scheme comprising the schedule information.

3. The electronic device of claim 1, wherein the communication processor is further configured to control the transceiver to transmit the signal according to the Wi-Fi direct-based second communication scheme in the at least one first period.

4. The electronic device of claim 1, wherein the communication processor is further configured to divide a time period between a start time of a first DW and a start time of a second DW into the at least one first period and the at least one second period, and
wherein each of the at least one first period and the at least one second period is a multiple of a time slot defined according to the NAN-based first communication scheme.

5. The electronic device of claim 1, wherein the communication processor is further configured to:
based on the NAN-based first communication scheme being in the active state, obtain NAN cluster synchronization information as the NAN cluster information;
based on the NAN-based first communication scheme being in the inactive state, perform a NAN passive scan operation;
based on neighboring NAN cluster information being received based on the NAN passive scan operation, obtain the received neighboring NAN cluster information as the NAN cluster information; and
based on the neighboring NAN cluster information is not being received based on the NAN passive scan operation, generate arbitrary NAN cluster information.

6. The electronic device of claim 1, wherein the communication processor is further configured to:
based on the NAN-based first communication scheme being in the active state, increase the GO intent by a first value; and
based on the NAN-based first communication scheme being in the inactive state, increase the GO intent by a second value lower than the first value.

7. The electronic device of claim 1, wherein the communication processor is further configured to increase the GO intent based on a frequency band of an access point connected in the STA mode-based third communication scheme.

8. The electronic device of claim 1, wherein the communication processor is further configured to obtain the schedule information after performing time synchronization on the NAN-based first communication scheme, the Wi-Fi direct-based second communication scheme, and the STA mode-based third communication scheme.

9. The electronic device of claim 1, further comprising a memory, wherein the communication processor is further configured to:
control the transceiver to transmit a discovery message of the Wi-Fi direct-based second communication scheme comprising NAN cluster information stored in the memory;
receive a response signal to the discovery message; and
obtain one having a higher master rank of NAN cluster information about a counterpart device in the response signal and the transmitted NAN cluster information, as the NAN cluster information.

10. The electronic device of claim 1, wherein the communication processor is further configured to:
based on the NAN cluster information being changed into information about another NAN cluster based on merging with the other NAN cluster, obtain schedule information changed based on the changed NAN cluster information, and
control the transceiver to transmit a signal according to the Wi-Fi direct-based second communication scheme, based on the changed schedule information.

11. The electronic device of claim 1, wherein the communication processor is further configured to, based on the NAN-based first communication scheme being activated while operating in the Wi-Fi direct-based second communication scheme, and another activated NAN cluster being detected, set a master rank of the NAN cluster information to a maximum value.

12. A method performed by an electronic device, the method comprising:
identifying whether a neighbor awareness networking (NAN)-based first communication scheme is in an active state or an inactive state;
based on the NAN-based first communication scheme being in the active state, obtaining NAN cluster information;
based on the NAN-based first communication scheme being in the active state, increasing a group owner (GO) intent in a Wi-Fi direct-based second communication scheme;
determining, based on the GO intent, that the electronic device is an owner device of the Wi-Fi direct-based second communication scheme, and dividing a time period into at least one first period and at least one second period, the time period being designated by a discovery window (DW) identified based on the NAN cluster information;
obtaining schedule information indicating that one communication scheme from among the Wi-Fi direct-based second communication scheme and a STA mode-based third communication scheme operates in the at least one first period, and the other communication scheme from among the Wi-Fi direct-based second communication scheme and the STA mode-based third communication scheme operates in the at least one second period, wherein the one communication scheme uses a same channel as the NAN-based first communication scheme and the other communication scheme uses a different channel than the NAN-based first communication scheme; and
transmitting a signal according to the Wi-Fi direct-based second communication scheme, based on the schedule information.

13. The method of claim 12, wherein the signal according to the Wi-Fi direct-based second communication scheme is a beacon signal of the Wi-Fi direct-based second communication scheme comprising the schedule information.

14. The method of claim 12, wherein the transmitting the signal comprises transmitting the signal according to the Wi-Fi direct-based second communication scheme in the at least one first period.

15. The method of claim 12, wherein the dividing the time period comprises dividing a time period between a start time of a first DW and a start time of a second DW into the at least one first period and the at least one second period, and
wherein each of the at least one first period and the at least one second period is a multiple of a time slot defined according to the NAN-based first communication scheme.

16. The method of claim 12, wherein the obtaining NAN cluster information comprising:
based on the NAN-based first communication scheme being in the active state, obtaining NAN cluster synchronization information as the NAN cluster information;
based on the NAN-based first communication scheme being in the inactive state, performing a NAN passive scan operation;
based on neighboring NAN cluster information being received based on the NAN passive scan operation, obtaining the received neighboring NAN cluster information as the NAN cluster information; and
based on the neighboring NAN cluster information is not being received based on the NAN passive scan operation, generating arbitrary NAN cluster information.

17. The method of claim 12, wherein the increasing the group owner (GO) intent in the Wi-Fi direct-based second communication scheme comprising:
based on the NAN-based first communication scheme being in the active state, increasing the GO intent by a first value; and
based on the NAN-based first communication scheme being in the inactive state, increasing the GO intent by a second value lower than the first value.

18. The method of claim 12, wherein the increasing the group owner (GO) intent in the Wi-Fi direct-based second communication scheme comprising increasing the GO intent based on a frequency band of an access point connected in the STA mode-based third communication scheme.

19. The method of claim 12, further comprising obtaining the schedule information after performing time synchronization on the NAN-based first communication scheme, the Wi-Fi direct-based second communication scheme, and the STA mode-based third communication scheme.

20. An electronic device comprising:
a communication module comprising a communication circuit; and
a processor operatively connected with the communication module,
wherein the processor is configured to:
identify whether a neighbor awareness networking (NAN)-based first communication scheme is in an active state or an inactive state;
based on the NAN-based first communication scheme being in the active state, obtain NAN cluster information;
based on the NAN-based first communication scheme being in the active state, increase a group owner (GO) intent in a Wi-Fi direct-based second communication scheme;
based on determining, based on the GO intent, that the electronic device comprising the communication module is a group owner of the Wi-Fi direct-based second communication scheme, and divide a time period into at least one first period and at least one second period, the time period is being designated by a discovery window (DW) identified based on the NAN cluster information;
obtain schedule information indicating that one communication scheme from among the Wi-Fi direct-based second communication scheme and a STA mode-based third communication scheme operates in the at least one first period, and the other communication scheme from among the Wi-Fi direct-based second communication scheme and the STA mode-based third communication scheme operates in the at least one second period, wherein the one communication scheme uses a same channel as the NAN-based first communication scheme and the other communication scheme uses a different channel than the NAN-based first communication scheme; and
control the communication module to transmit a signal according to the Wi-Fi direct-based second communication scheme, based on the schedule information.
